(19) United States
(12) Patent Application Publication
(10) Pub. No.: US 2010/0311866 A1
(43) Pub. Date: Dec. 9, 2010

(54) HEIRARCHIAL POLYMER-BASED NANOCOMPOSITES FOR EMI SHIELDING

(75) Inventors: Jijun Huang, Cambridge, MA (US); Joey L. Mead, Carlisle, MA (US)

Correspondence Address: PEARSON & PEARSON, LLP, 10 GEORGE STREET, LOWELL, MA, 01852, US

(73) Assignee: UNIVERSITY OF MASSACHUSETTS, Boston, MA (US)

(21) Appl. No.: 12/479,184

(22) Filed: Jun. 5, 2009

(51) Int. Cl. G21F 1/10

(52) U.S. Cl. 523/137

(57) ABSTRACT

Polymer-based nanocomposites and a method for forming polymer-based nanocomposites for EMI shielding includes three nanofillers used in a formation of a hierarchy in structure, length, size, and dimension. The nanofillers formulation comprises 18 wt % of nickel-coated carbon fibers (NCCB), 7 wt % of carbon nanofibers, and 2 wt % of multi-walled carbon nanotubes mixed within an ABS copolymer matrix of 72 wt % for effective EMI shielding.

### BACKGROUND OF THE INVENTION

1. Field of the Invention

This invention relates generally to polymer based nanocomposites for shielding electromagnetic interference (EMI), and in particular, to nanocomposites comprising a polymeric matrix and a heirarchial nanofiller system containing multiple types of nanofillers with a hierarchy, in structure, length, size, and dimension for high EMI shielding effectiveness and reduced weight.

2. Description of Related Art

EMI effect is common as a result of extensive use of electronics, computing and telecommunicating equipment, and other devices/appliances that employ power, electronic signals, optical-electronic signals, and, electromagnetic wave transmission, etc. The EMI effect, also called electromagnetic pollution, has become an increasingly important issue nowadays, with the proliferation of electronics in society. Thus, it is always desirable to reduce and minimize such EMI effects. Under certain circumstances, it is essential to maximally avoid the EMI effect, as the EMI effect may cause interruption and even failure of normal functions of the aforementioned electronics, equipment, and especially airplane equipment where weight is critical. The EMI effect is not only problematic to the solid state electronics and equipment, but also harmful to the heath of human beings. At severe conditions, the EMI effect at high frequencies, e.g., use of a wireless phone (in early days) for very long time, has been reported in Asia to cause skin cancer.

Many efforts have been taken to reduce the EMI effect. In early days, metallic housings were used for mitigation of the EMI effect. The metal housing, however, are generally heavy and bulky. Recently, conductive metallic flakes, metallic fibers, metal-coated glass and carbon fibers, and powders, like carbon black, have been used to form composite materials with plastics and/or rubbers in order to provide protection against EMI but with advantages in lighter weight, lower cost, and ease of fabrication compared with the metal housings.

Incorporation of a synergistic combination of metal flakes and conductive metal or metal coated fiber has also been patented. More recently, polymer blends with a conductive/semi-conductive polymer as one of the components have been fabricated. Further, attempts have been made to utilize new types of conductive nanofillers, e.g., nanofibers or multi-walled carbon nanotubes, to formulate composites with plastics for reduction of the EMI effect.

U.S. Pat. No. 4,566,990 issued Jan. 28 1986 to Nan-I Liu et al. discloses thermoplastic compositions having high electromagnetic/radio frequency interference (EMI/RFI) shielding effectiveness as a result of incorporating therein a synergistic combination of conductive metal fillers such as metal flake and metal or metal coated fiber in polymer blends. The composition comprises (a) one or more thermoplastic polymers; (b) from about 25 to about 50% by wt., preferably from about 25 to about 40% by wt., based on the total composition of metal flake and (c) from about 2 to about 12% by wt., preferably from about 4 to about 8% by wt., based on the total composition of metal flakes to metal or metal coated fiber is about 4:1 to about 14:1, preferably from about 6:1 to about 10:1. The thermoplastic polymers include polyesters, polycarbonates, polyamides, etc. Suitable flakes may be prepared from aluminum, copper, silver or nickel or alloys thereof. Metal fibers may be selected from silver, copper, nickel, aluminum or stainless steel. The metal coated fibers comprise a base fiber of glass, graphite and the like upon which a metal coat of nickel, silver, copper or aluminum is applied. The compositions may be molded, formed, or extruded into various structures. However, additional weight is not desirable in certain applications.

U.S. Pat. No. 5,399,295 issued Mar. 21, 1995 to Jeffrey Gamble et al. discloses an EMI shielding composite sheet comprising a continuous matrix of a synthetic resinous material having randomly dispersed therein to conductive fibers and a particulate, conductive or semi-conductive filler. The conductive fibers include aluminum, nickel, copper, iron and steel fibers, metallized glass, metallized graphite or metallized plastic fibers. The conductive fibers are dispersed in the resin matrix such that they lie substantially in the plane defined by the composite sheet and are randomly oriented in two dimensions within the plane. The particulate conductive or semi-conductive filler material is of small size and may include silicon, silicon dioxide, germanium, selenium and carbon black (which is preferred). The shielding effectiveness of the composite is in the range of 20 db to 80 db depending on the combination of fillers used in the resinous matrix. However, the total weight of the EMI shielding composite can be a problem in certain airplane applications. In addition, the preparation process is specifically related to slurry process (i.e., paper-making) requiring a polymeric binder, which may not be easily adapted to typical composites preparation methods. When structural and mechanical properties are critical to the composites, the micron-sized filler may render earlier failure. Furthermore, it is unclear what the EMI shielding effectiveness looks like at lower and higher frequencies, as only EMI shielding effectiveness at 1 GHz is mentioned in the patent.

U.S. Pat. No. 7,118,693 issued Oct. 10, 2006 to Paul J. Glatkowski et al. discloses conformal coatings comprising carbon nanotubes that provide shielding against electromagnetic interference (EMI). The conformal coating comprises an insulating layer and a conducting layer containing electrically conductive materials that provide EMI shielding such as carbon black, carbon buckeyballs, carbon nanotubes, chemically-modified carbon nanotubes and combinations thereof. The conducting layer provides EMI shielding properties in the 10-70 dB attenuation range. While the conformal coating imparts certain level of EMI shielding, it is generally not considered to be robust enough as a structural material and thus has limited applications such as in aircraft,

### SUMMARY OF THE INVENTION

Accordingly, it is therefore an object of this invention to provide a polymeric-based composition having a combination of nanofillers for creating a hierarchy of surface structure, length, size and dimension for high EMI shielding effectiveness.

It is another object of this invention to provide lighter weight nanocomposite materials with high EMI shielding effectiveness.

It is yet another object of this invention to employ nanofillers in combination to fabricate polymeric nanocomposites for EMI shielding where both EMI shielding and structural/mechanical properties must be considered.

These and other objects are further accomplished by a polymeric-based composition with nanocomposites having a high electromagnetic interference shielding effectiveness comprising a polymer matrix including a thermoplastic resin, a first nanofiller comprises nickel-coated carbon fibers, a second nanofiller comprises carbon nanofibers, a third nanofiller comprises multi-walled carbon nanotubes, and the first nanofiller, the second nanofiller and the third nanofiller are combined in the polymer matrix. The thermoplastic resin is acrylonitrile-butadiene-styrene, and it is present in an amount of about 72% by weight; the first nanofiller is present in an amount of about 18% by weight; the second nanofiller is present in an amount of about 7% by weight; and the third nanofiller is present in an amount of about 2% by weight.

The objects are further accomplished by a method for preparing a polymeric-based composition having a high electromagnetic interference shielding effectiveness comprising the steps of providing a polymer matrix consisting of acrylonitrile-butadiene-styrene (ABS) material, preparing a solution/suspension of multi-walled carbon nanotubes with dodecylbenzenesulfonic acid and de-ionized water added together in a ratio of 10:1:1000 by parts, adding the solution/suspension to the ABS material, premixing the solution/suspension and the ABS material at approximately 107° C. for at least 12 hours, batch mixing the premix of the solution/suspension and the ABS material at approximately 225° C. with carbon nanofibers and hot water processed NCCB, milling the resulting polymer matrix with three nanocomposites to obtain small granules, compression molding at about 225° C. the small granules to obtain sheets of the polymer matrix with three nanocomposites. The step of batch mixing comprises the steps of mixing the premix at 10 rpm until completely melted, and mixing the premix of the solution/suspension and the ABS material, the carbon nanofibers, and the hot water processed NCCB at 60 rpm.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a process flow chart for preparing a polymeric nanocomposite embodiment according to the present invention.

FIG. 2 is a graph which shows EMI attenuation over a frequency range between 800 MHz to 18,000 MHz.

### DESCRIPTION OF ILLUSTRATIVE EMBODIMENT

Heirarchial polymer-based nanocomposites are effective and efficient in shielding electromagnetic interference (EMI) and/or electrostatic discharge. Embodiments of the heirarchial nanofiller system includes metal-coated carbon fibers, carbon nanofibers, conductive nanographite sheets, graphene, multi-walled and single-walled carbon nanotubes, conductive nanowire and nanoparticles, and any other conductive nanofillers. In a preferred embodiment three types of such nanofillers are used in the formation of a hierarchy in structure, length, size, and dimension for effective shielding of EMI.

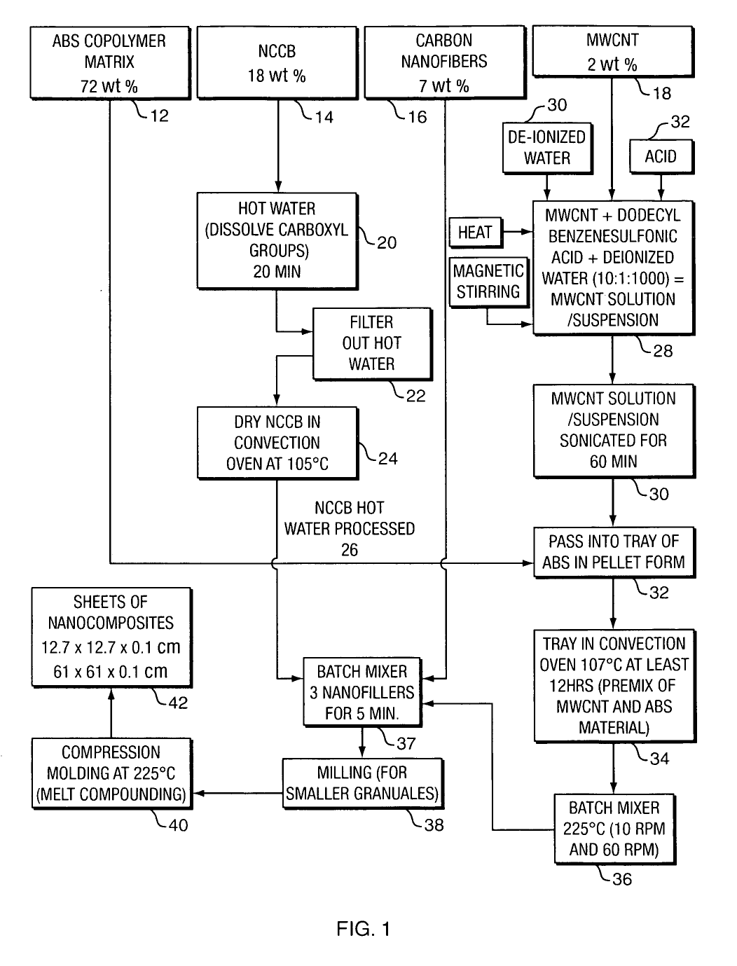

Referring to FIG. 1, a flowchart shows the process 10 for preparing the polymeric-based composition including nanocomposites for electromagnetic interference (EMI) shielding according to the present invention. The polymeric matrix includes thermoplastic, thermoplastic rubbers/elastomers, thermoset polymers, and polymers that can only be processed via solution. An acrylonitrile-butadiene-styrene (ABS) copolymer, is selected as a matrix polymer 12. Three nanofillers are used together in a formulation comprising a nickel-coated carbon fiber (NCCB) 14 (the nickel layer is in nano-scale while the carbon fiber is in micro-scale), a carbon nanofiber 16 and a multi-walled carbon nanotube (MWCNT) 18. The formulation is composed of 72 wt % of ABS copolymer 12, 18 wt % NCCB 14, 7 wt % of carbon nanofiber 16 and 2 wt % of MWCNT 18.

The nickel-coated carbon fiber 14 has a nominal diameter of 7 microns, the nickel layer is 0.25 micron in thickness, and the length of the fiber is 6 mm. The carbon nanofiber 16 has an average fiber diameter of 107 microns and a length of 30-100 microns. The multi-walled carbon nanotubes have an outside diameter of 20-40 mm (0.02-0.04) microns), an inside diameter of 5-10 mm (0.005-0.010 microns) and a length of 10-30 microns.

The components may be obtained as follows: the ABS copolymer 12 from Sabic Innovative Plastics of Pittsfield, Mass.; the NCCB 14 from Toho Tenax America, Inc. of Rockwood, Tenn.; the carbon nanofiber 16 from Pyrogrof Products, Inc., of Cedarville, Tenn.; and the MWCNT 18 from Cheap Tubes Inc., of Brattleboro, Vt.

In Step 20 of the process, the NCCB 14 is added into hot water and retained for approximately 20 minutes to dissolve the carboxyl groups that are harmful for the nickel coating.

In Step 22 the hot water is filtered out, and in Step 24 the NCCB 14 is dried in a convection oven at 105° C. for approximately 10 hours for subsequent melt compounding in Steps 36 and 37.

In Step 28 the MWCNT 18, dodecylbenzenesulfonic acid 32 and de-ionized water 30 are added together (10:1:1000 by parts) in a beaker to form a solution with the aid of heat in the range of 35° C. to 70° C. and magnetic stirring (300-600 rpm). The acid 32, which serves as a dispersing agent, is first added into the de-ionized water 30 to form the solution; upon complete dissolving of the acid 32, the MWCNT 18 is added into the solution. The heat and magnetic stirring are necessary for obtaining an MWCNT solution/suspension.

In Step 30 the formed MWCNT solution/suspension is further sonicated for 60 minutes to allow the MWCNT 18 to be better dispersed. In Step 32 the MWCNT sonicated solution/suspension is poured into a tray of the ABS copolymer 12 material (in pellet form), and in Step 34 the tray is placed into a convection oven for drying at 107° C. for at least 12 hours. In this way, the MWCNT 18 is pre-mixed with the ABS copolymer 12 material.

In step 36 the ABS copolymer 12 premixed with MWCNT 18 is put into a Brabender® plasti-corder batch mixer (with 60 cubic centimeter of capacity) and the temperature set to 225° C. and mixing speed set to 10 rpm. Upon complete melting of the pre-mixed ABS copolymer and MWCNT 18, the rpm is increased from 10 to 60. Then in Step 37 the hot-water processed nickel-coated carbon fiber (NCCB) 14 and carbon nanofibers 16 are added into the batch mixer respectively to mix together the three nanofillers including the pre-mixed ABS copolymer 12 with MWCNT for 5 minutes. The mixed materials are removed from the plastic-corder after completion of melt compounding and subjected to milling in Step 38 to obtain much smaller granules for subsequent compression molding at 225° C. in Step 40.

In Step 42 a sheet of the polymeric nanocomposites for EMI shielding tests is obtained by the compression molding performed at 225° C. in Step 40 to mold the mixture by melt compounding into a sheet of either 12.7×12.7×0.1 cm or 61×61×0.1 cm.

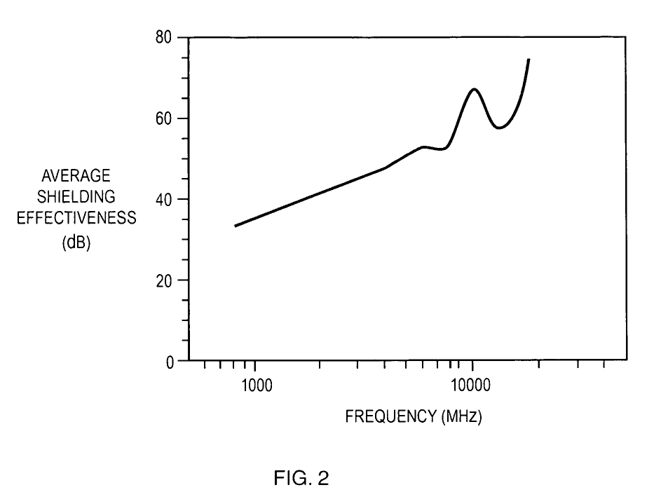

Referring to FIG. 2, a graph shows the average shielding effectiveness in dB over a frequency range between 800 MHz to 18,000 MHz (0.8-18 GHz) for the present embodiment prepared by the process of FIG. 1. The three nanocomposites embodiment was tested under IEEE 299 standard. As shown in the graph, the shielding effectiveness increases significantly with frequency from 33 to 73 dB.

The benefits of this embodiment of polymer-based nanocomposites include greater surface and interfacial area and a better conductivity for charge dispersion, lighter weight and significantly increased EMI shielding over a broader frequency range. The polymer-based nanocomposites can be processed in batch and they can be extruded, foamed, molded, solution-cast, patterned or self-assembled into a variety of forms for EMI shielding applications.

In the present embodiment, multiple nanofillers are purposely chosen in combinations to form the nanocomposites. These nanofillers tend to form a hierarchy in structure, length, size, and dimension due to their own distinct characteristics such as a unique length scale. The hierarchy is mainly controlled by the characteristics of the nanofillers, i.e., the diameter and length of each nanofiller and the thickness of nickel coating in the case of nickel-coated carbon fiber. Nanofillers provide greater surface/interface area after dispersion which is necessary for higher shielding effectiveness. This hierarchy is believed to be essential in order to achieve high EMI shielding in the nanocomposites. For composites prepared for EMI shielding, nanofillers/nanoparticles generally may not be perfectly uniformly dispersed into a polymer matrix. The nanocomposite with only a single nanofiller, e.g., multi-walled and single-walled carbon nanotubes, has been shown not to impart high EMI shielding effectiveness. The composites comprising micro-sized filler (e.g., fiber) have been shown not to exhibit effective EMI shielding, unless special alignment/orientation of the filler is rendered, which is generally unavailable in typical composites preparation techniques. The formed hierarchy among aforementioned nanofillers is desirable and necessary for EMI shielding especially at high frequencies, e.g., more than 5 GHz, coupled with the required mechanical properties for many applications. In addition, the formed hierarchy may generate lighter weight nanocomposites as a result of using less nanofillers than the micro-sized fillers to achieve a similar level of EMI shielding. The prior art does not disclose the role of hierarchy among the nanofillers in influencing EMI shielding, and does not disclose designing the nanocomposites for EMI shielding with a hierarchy in structure, length, size, and dimension among the nanofillers as described in the present embodiment.

This invention has been disclosed in terms of a preferred embodiment. It will be apparent that many modifications can be made to the disclosed method and composition without departing from the invention. Therefore, it is the intent of the appended claims to cover all such variations and modifications as come within the true spirit and scope of this invention.

What is claimed is:

1. A polymeric-based composition with nanocomposites having a high electromagnetic interference shielding effectiveness comprising:
a polymer matrix includes a thermoplastic resin;
a first nanofiller comprises nickel-coated carbon fibers;
a second nanofiller comprises carbon nanofibers;
a third nanofiller comprises multi-walled carbon nanotubes, and
said first nanofiller, said second nanofiller and said third nanofiller being combined in said polymer matrix.

2. The composition as recited in claim 1 wherein said thermoplastic resin is acrylonitrile-butadiene-styrene.

3. The composition as recited in claim 2 wherein said thermoplastic resin is present in an amount of about 72% by weight.

4. The composition as recited in claim 1 wherein said first nanofiller is present in an amount of about 18% by weight.

5. The composition as recited in claim 1 wherein said second nanofiller is present in an amount of about 7% by weight.

6. The composition as recited in claim 1 wherein said third nanofiller is present in an amount of about 2% by weight.

7. A method for preparing a polymeric-based composition having a high electromagnetic interference shielding effectiveness comprising the steps of:
providing a polymer matrix consisting of acrylonitrile-butadiene-styrene (ABS) material;
preparing a solution/suspension of multi-walled carbon nanotube with dodecylbenzenesulfonic acid and de-ionized water added together in a ratio of 10:1:1000 by parts;
adding said solution/suspension to said ABS material;
premixing said solution/suspension and said ABS material at approximately 107° C. for at least 12 hours;
batch mixing said premix of said solution/suspension and said ABS material at approximately 225° C. with carbon nanofibers and hot water processed NCCB;
milling the resulting polymer matrix with three nanocomposites to obtain small granules;
compression molding at about 225° C. said small granules to obtain sheets of said polymer matrix with three nanocomposites.

8. The method as recited in claim 7 wherein said step of batch mixing comprises the steps of mixing said premix at 10 rpm until completely melted, and mixing said premix of said solution/suspension and said ABS material, said carbon nanofibers, and said hot water processed NCCB at 60 rpm.
